(19) United States
(12) Patent Application Publication
(10) Pub. No.: US 2008/0013182 A1
(43) Pub. Date: Jan. 17, 2008

(54) Two-stage laser-beam homogenizer

(76) Inventor: Joerg Ferber, Angerstein (DE)

Correspondence Address: STALLMAN & POLLOCK LLP, 353 SACRAMENTO STREET, SUITE 2200, SAN FRANCISCO, CA, 94111, US

(21) Appl. No.: 11/827,697

(22) Filed: Jul. 13, 2007

Related U.S. Application Data
(60) Provisional application No. 60/831,333, filed on Jul. 17, 2006.

(51) Int. Cl. G02B 27/10

(52) U.S. Cl. 359/619

(57) ABSTRACT

Apparatus for a mask-projection laser system with a laser beam includes a homogenizer having entrance and exit arrays of cylindrical lenses spaced apart in the direction of propagation of the laser beam. A pre-homogenizer is arranged to pre-homogenize the beam such that entrance pupil of the projection lens is about uniformly illuminated.

### PRIORITY CLAIM

This application claims the priority of U.S. Provisional Patent Application No. 60/831,333, filed Jul. 17, 2006, the complete disclosure of which is hereby incorporated by reference.

### TECHNICAL FIELD OF THE INVENTION

The present invention relates in general to laser drilling. The invention relates in general to mask-projection laser systems with optical arrangements for homogenizing the laser beam wherein a plurality of holes are drilled simultaneously in a substrate by using a photomask with a corresponding plurality of apertures.

### DISCUSSION OF BACKGROUND ART

An excimer laser emitting pulsed radiation in the ultraviolet (UV) region of the electromagnetic spectrum can be used to simultaneously drill a plurality of relatively small apertures, for example having a diameter less than about 50 micrometers (μm), in a substrate. In a preferred method for such simultaneous aperture drilling, UV radiation from the excimer laser is used to illuminate a mask having a plurality of apertures therein, and an image of the mask, i.e., of the apertures in the mask is projected onto the substrate using a reduction lens, for example a 5-times reduction lens. A plurality of pulses are delivered from the laser and the intensity of radiation in the mask-aperture images is sufficient that substrate material is eroded away, and the aperture-images, within a few seconds, produce corresponding actual apertures in the substrate.

This method is particularly suited to drilling a plurality of apertures having the same cross-section form throughout the depth of the aperture, i.e., throughout the depth of the substrate, such as inkjet apertures. Depending on the design of a particular inkjet head, as many as 300 apertures may have to be drilled in an area of approximately 0.5 millimeters (mm)×15 mm. The method, however, is only effective to the extent that telecentricity and uniformity of illumination at the substrate are maintained. Telecentricity of the illumination at the substrate can be provided by careful optical design of a projection system for the laser beam. Telecentricity is primarily responsible for providing that the longitudinal axes of drilled holes are parallel to each other, which, in turn, provides that each aperture projects or “squirts” ink in the same direction. Uniformity of illumination is primarily responsible for ensuring that each aperture has the same cross-section dimensions, which, in turn, ensures that each aperture projects the same volume of ink.

It is well known that telecentricity is influenced by the intensity distribution in the entrance pupil of the projection lens. Using a state-of-the-art homogenizer, the intensity distribution in the pupil is a spot matrix with an envelope that reflects the intensity distribution entering the homogenizer, i.e. basically the raw beam of the laser (usually, the raw beam is scaled and collimated by an anamorphic telescope first). This results from the fact that the intermediate foci of the first homogenizer array are imaged by the second array, the condenser lens and the field lenses to the entrance pupil of the projection lens. Thus, small deviations in the raw beam parameters, such as beam size, beam pointing, beam divergence, directly influence the intensity distribution within the pupil and therefore the concentricity of the drilled holes. Furthermore, the raw-beam-like shape of the envelope of the pupil spot causes systematic telecentric errors, which can be compensated partially only by means of de-adjusting the Z-axis position of the field lenses.

### SUMMARY OF THE INVENTION

The present invention is directed to optical apparatus for illuminating a mask in a mask plane with radiation from a laser beam, which simultaneously results in telecentric illumination at the substrate, so that equal and concentric holes can be drilled. In one aspect, apparatus in accordance with the present invention comprises a homogenizer having entrance and exit arrays of cylindrical lenses spaced apart in the direction of propagation of the laser beam and a condenser lens arranged to project light from the exit array of the homogenizer into the mask plane. The apparatus further comprises a pre-homogenizer arranged to pre-homogenize the beam such that entrance pupils of cylindrical lenses in the entrance lens array of the homogenizer are about uniformly illuminated.

With the pre-homogenizer, the homogenizer is illuminated homogeneously, and thus homogenizer illumination is independent on deviations of the raw beam parameters, such as beam size, beam divergence, or beam pointing. The resulting illumination of the pupil is still a spot matrix, but with broader spots and an envelope which is a flat line, this means uniform, and which thus is independent of the raw beam parameters. As a consequence, concentricity will be independent on variations of the raw beam. Furthermore, any systematic telecentricity error induced by the state-of-the-art set-up is avoided by using the present invention.

In a preferred embodiment of the invention, the pre-homogenizer includes entrance and exit arrays of cylindrical lenses arranged parallel to each other, a condenser lens and a field lens. The pre-homogenizer divides the laser beam into a first plurality of first beam portions and overlaps the first beam portions at the entrance lens array of the homogenizer. The homogenizer divides the overlapped first beam portions into a plurality of second beam portions and overlaps the second beam portions at the mask plane.

Preferably, the first and second arrays include the same number of cylindrical lenses, and the third and fourth arrays include the same number of cylindrical lenses. The number of lenses in an array is preferably between about 3 and 30.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1A is a long-axis view schematically illustrating one preferred embodiment of the two-stage homogenizer to be used in a line-image-projecting optical apparatus in accordance with the present invention, including a homogenizer and a pre-homogenizer, each thereof including first and second spaced-apart cylindrical microlens arrays.

FIG. 1B is a short-axis view schematically illustrating further details of the optical apparatus of FIG. 1A.

FIG. 2 is a graph schematically illustrating energy distribution in the long-axis of a laser beam from an excimer laser.

FIG. 3 is a bar chart schematically illustrating average intensity in the entrance pupil of the projection lens when using 15 cylindrical lenses in a first cylindrical lens array of a prior-art line image projection apparatus including only the beam-homogenizer of the system of FIGS. 1A and 1B and illuminated by a laser beam having the intensity distribution of FIG. 2.

FIG. 4 is a principle bar chart schematically illustrating average intensity in the entrance pupil of the projection lens when using 15 cylindrical lenses in a first cylindrical lens array of the beam-homogenizer of FIGS. 1A and 1B when the laser beam of FIG. 2 is pre-homogenized by the pre-homogenizer of FIGS. 1A and 1B.

FIG. 5A is a long-axis view schematically illustrating another preferred embodiment of a line-image-projecting optical apparatus in accordance with the present invention, including a homogenizer and a pre-homogenizer, with the pre-homogenizer including first and second spaced-apart cylindrical microlens arrays and the homogenizer including first and second spaced-apart cylindrical microlens arrays and third and fourth spaced-apart cylindrical microlens arrays arranged such that homogenization occurs in both the long-axis and the short-axis.

FIG. 5B is a short-axis view schematically illustrating further detail of the optical apparatus of FIG. 5A.

### DETAILED DESCRIPTION OF THE INVENTION

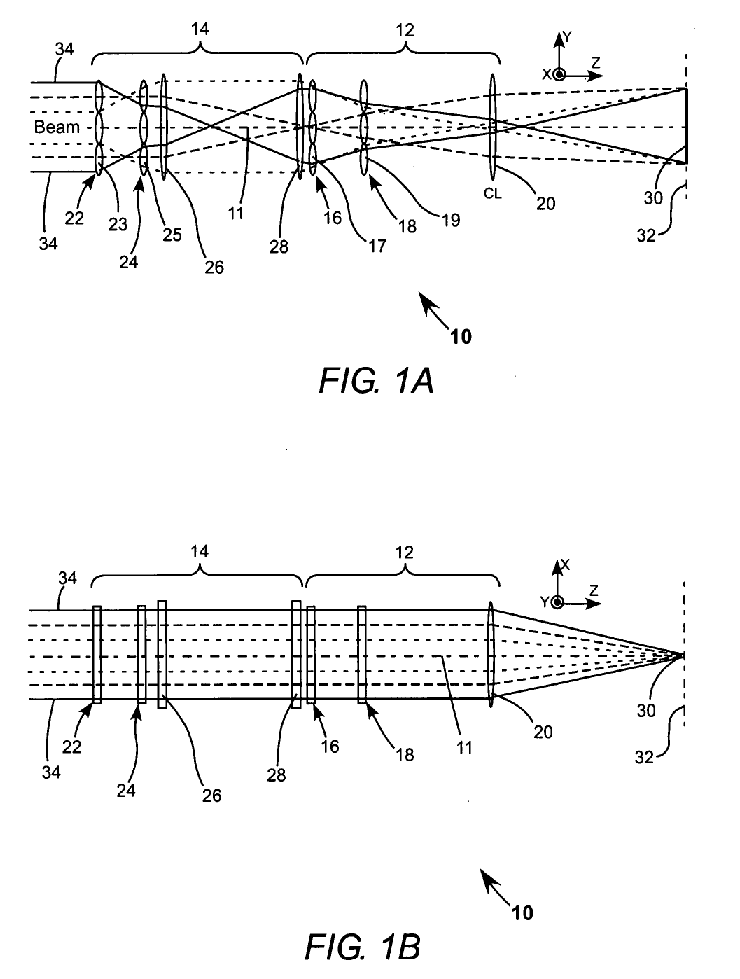

Turning now to the drawings, wherein like features are designated by like reference numerals, FIG. 1A and FIG. 1B are respectively long-axis (Y-axis) and short-axis (X-axis) views schematically illustrating one preferred embodiment 10 of optical apparatus in accordance with the present invention. Apparatus 10 includes a homogenizer 12 including an array 16 of cylindrical lenses 17, an array 18 of cylindrical lenses 19, and a condenser lens 20. Only three lenses are depicted in the lens arrays for simplicity of illustration. In practice, a larger number of lenses per array is preferred, for example, fifteen lenses per array. Preferably there is an equal number of lenses in each array, and the focal lengths of the lenses in each array are equal.

Apparatus 10 further includes a pre-homogenizer 14 including an array 22 of cylindrical lenses 23, an array 24 of cylindrical lenses 25, a cylindrical condenser lens 26 and a cylindrical field lens 28. Preferably lenses 26 and 28 have the same Y-axis focal length. Here again, only three lenses per array are depicted for simplicity of illustration. Again, there is preferably an equal number of lenses in each array and the focal lengths of the lenses in each array are equal. Components of the homogenizer and pre-homogenizer are aligned in the Y-axis on an optical axis 11.

Arrays 22 and 25 of pre-homogenizer 14 are spaced apart by a distance about equal to the focal length of the lenses in the second array. Lens 26 and array 16 are spaced apart by a distance about equal to the focal length of lens 26. Lens 28 is positioned immediately in front of the array 16. Lens arrays 16 and 18 of homogenizer 12 are spaced apart by a distance about equal to the focal length of array 18. Condenser lens 20 is spaced apart from the mask plane by a distance about equal to the focal length of the condenser lens.

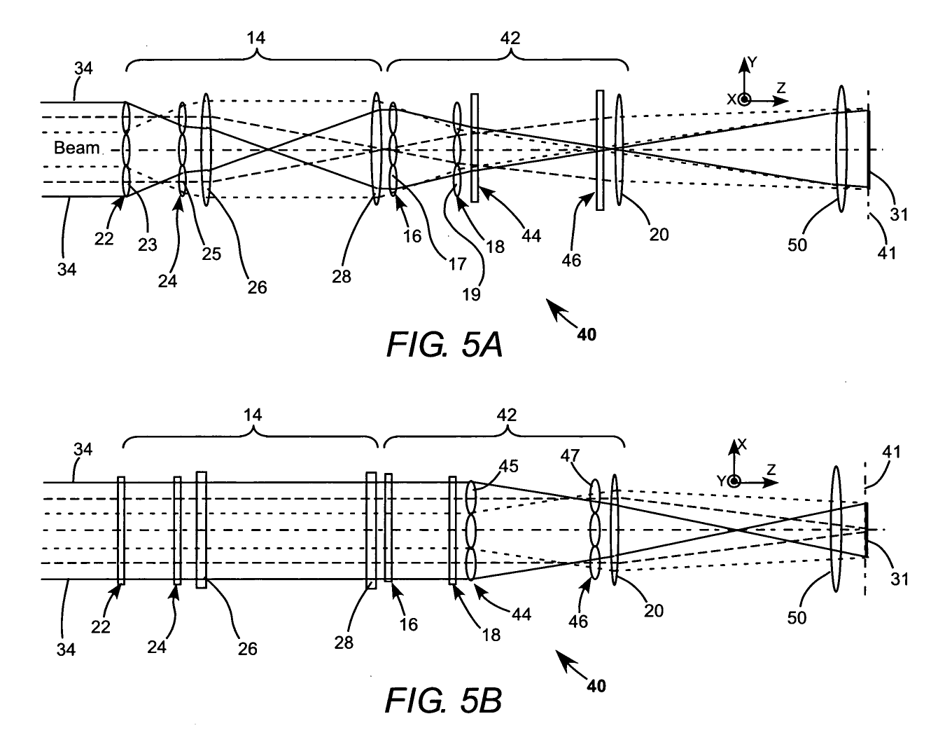

FIGS. 1A and 1B illustrate the principle of the inventive two-stage homogenizer with reference to the long-axis only. In practice, it is preferable to homogenize both the long axis and the short axis as will be discussed with reference to FIG. 5. Anamorphic field lenses (not shown) are positioned in front of the mask plane. A mask in the mask plane is imaged onto a substrate (not shown) by a projection lens (not shown) shown. A beam forming telescope (not shown) may be provided ahead of apparatus 10 for adapting the beam size of a raw beam to the entrance aperture of pre-homogenizer 14. These beam shaping, field-lens and projection arrangements are well known in the art and a detailed description thereof is not necessary for understanding principles of the present invention, accordingly such a detailed description is not presented herein. A detailed description of such arrangements is provided in U.S. Pre-Grant Publication No. 2007/0109519, assigned to the assignee of the present invention, and the complete disclosure of which is hereby incorporated by reference. U.S. Pre-Grant Publication No. 2007/0148567, also assigned to the assignee of the present invention provides information about drilling inkjet orifices and is also incorporated herein by reference.

An input beam is depicted in FIG. 1A bounded by solid lines 34. Lens array 22 effectively divides the beam into as many portions as there are lenses in the array. Ray traces from each of the outermost lenses are depicted by one solid line, one long-dashed line, and one short-dashed line. The beam is projected by apparatus 10 into a line of radiation 30 in the mask plane 32 of the apparatus in which a projection mask (not shown) would be located. The focal plane can be designated a mask plane. The homogenizer divides the overlapped beam portions at array 16 thereof into a further plurality of beam portions and overlaps these beam portions at the mask plane.

As can be seen from the ray trace of FIG. 1A the beam portion projected by each of the two outer lenses fills the entire length of line 30. Those skilled in the art will recognize that this will also be true for the beam portion projected by the central lens. Independent of the number of lenses in the array, the beam portion projected by each would fill the entire length of the line. This serves to sum the original intensity distributions in each beam portion, providing near-uniform illumination (in the Y-axis) in the line of radiation. In the X-axis, only lens 20 has any effect on the beam. Lens 20 focuses the beam to a very narrow width, for example between about 5 micrometers (μm) and 50 μm, in focal plane 32. This width of the line is very much less than the length of the line, which can be tens of millimeters long.

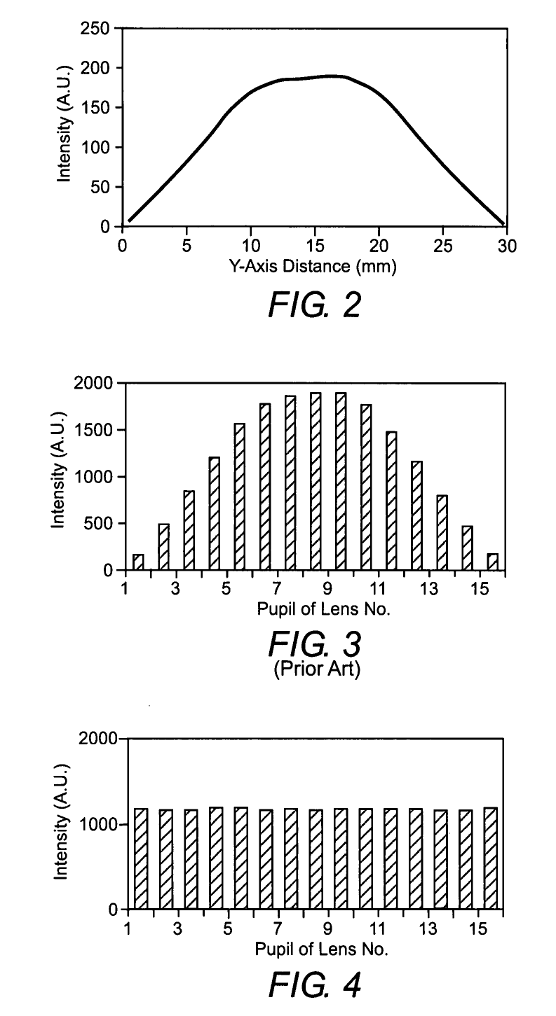

FIG. 2 is graph schematically illustrating relative intensity as a function of Y-axis position in beam spots of a beam to be projected by apparatus 10. FIG. 3 schematically illustrates what the relative average Y-axis beam-intensity would be at the input pupil of the projection lens in a set-up with 15 lenses in the arrays of the homogenizer, and pre-homogenizer 14 was not included in apparatus 10. This would be a prior-art apparatus having only a beam homogenizer. It can be seen that the energy distribution among the spots generally follows the beam intensity profile of FIG. 2.

FIG. 4 schematically illustrates average relative intensity at the input pupil of the projection lens using the exemplary 15 lenses in the arrays of the homogenizer in an example of the inventive apparatus 10 integrated into a mask-projection laser system, including pre-homogenizer 14. It can be seen that there is already a relatively high degree of uniformity at the input pupils of the lenses of the homogenizer. This provides for an even greater Y-axis uniformity in line of radiation 30.

In the apparatus of FIGS. 1A and 1B, the beam is homogenized in one axis (the Y-axis) only. In the X-axis it is desired to focus the line to as narrow a width as possible to form the line of radiation and to maximize the intensity of radiation in the line of radiation. In other applications, it may be necessary to illuminate an area rather than a line. In such a case, the illuminated area may have comparable dimensions in both the Y-axis and the X-axis and it is preferable that the beam be homogenized in each axis.

FIG. 5A and FIG. 5B are respectively Y-axis and X-axis views schematically illustrating another preferred embodiment 40 of apparatus in accordance with the present invention arranged to illuminate an area 31 in a focal plane 41 of the apparatus. Apparatus 40 is similar to apparatus 10 of FIGS. 1A and 1B with an exception that homogenizer 12 of apparatus 10 is replaced by a homogenizer 42 arranged to further homogenize the pre-homogenized beam in both the X-axis and the Y-axis while projecting the beam into a rectangular area rather than a line. Furthermore, a field lens 50 is indicated. Field lens 50 is depicted as a single spherical lens element for simplicity of illustration. However, this field lens could be an anamorphic group including a cylindrical lens doublet for the long-axis and another cylindrical lens for the short-axis.

Homogenizer 42 is similar to homogenizer 12 but includes an additional pair 44 and 46 of spaced-apart cylindrical lens arrays including cylindrical lenses 45 and 47 respectively. Arrays 44 and 46 are located behind arrays 16 and 18 in the direction of beam propagation and have positive optical power in the X-axis and zero optical power in the Y-axis. Here again, arrays having only three lenses each therein are depicted for simplicity of illustration. In practice, more lenses would be desirable as noted above for the other arrays. A field lens 50 having equal, positive optical power in each axis, for example a spherical lens, or an anamorphic field lens group, is located behind X-axis cylindrical lens array 46 in the direction of propagation. In apparatus 10, homogenizer 42, in cooperation with field lens 50, focuses pre-homogenized beam 34 into area 31 in focal plane 41 of the apparatus. The preferred spacing of optical elements is similar to like elements of apparatus 10. Additionally, cylindrical-lens arrays 44 and 46 are spaced apart by about twice the X-axis focal length of the lenses in the array.

The FIG. 5 embodiment includes only one pre-homogenizer. It is within the scope of the subject invention to provide a second pre-homogenizer the cylindrical arrays oriented perpendicular to the first pre-homogenizer.

In summary, the present invention is described above in terms of preferred embodiments. The apparatus is not limited, however, to the embodiments described and depicted. Rather the invention is defined by the claims appended hereto.

What is claimed is:

1. Optical apparatus for illuminating a mask in a mask plane with radiation from a laser beam, comprising:
a pre-homogenizer including first and second arrays of cylindrical lenses arranged parallel to each other, a first condenser lens and a first field lens;
a homogenizer including third and fourth arrays of cylindrical lenses arranged parallel to each other and parallel to the cylindrical lenses in the first and second arrays, and second condenser lens; and
wherein the pre-homogenizer divides the laser beam into a first plurality of first beam portions and overlaps the beam portions at the third lens array of the homogenizer, and the homogenizer divides the overlapped first beam portions into a plurality of second beam portions and overlaps the second beam portions at the mask plane.

2. The apparatus of claim 1, wherein the cylindrical lenses in the first array have a first focal length and the cylindrical lenses in the second array have a second focal length, and the first and second arrays are spaced apart by a distance about equal to the second focal length.

3. The apparatus of claim 2, wherein the condenser lens of the pre-homogenizer and the field lens of the pre-homogenizer have equal focal lengths.

4. The apparatus of claim 1, wherein the first condenser lens has a third focal length and the first field lens has fourth focal length and the first field lens and the first condenser lens are spaced apart by about the third focal length.

5. The apparatus of claim 1, wherein the apparatus projects the beam into a line of radiation in the mask plane with the line having a length perpendicular to the orientation of the cylindrical lenses in the first, second, third, and fourth arrays, the line having a width very much less than the length thereof.

6. The apparatus of claim 1, wherein the homogenizer further includes fifth and sixth spaced-apart arrays of cylindrical lenses arranged parallel to each other and perpendicular to the lenses in the first second third and fourth arrays, the fifth and sixth arrays being located between the fourth array and the condenser lens.

7. The apparatus of claim 6, further including a second field lens located between the second condenser lens and the mask plane.

8. The apparatus of claim 7, wherein the apparatus projects the beam into an area in the mask plane having comparable dimensions in first and second transverse axes of the apparatus perpendicular to each other.
